(19) United States
(12) Patent Application Publication
(10) Pub. No.: US 2004/0232783 A1
(43) Pub. Date: Nov. 25, 2004

(54) Electric machine, especially an alternator for motor vehicles

(76) Inventors: Horst Braun, Stuttgart (DE); Holger Scholzen, Stuttgart (DE); Peter Urbach, Reutlingen (DE); Holger Haussmann, Metzingen (DE); Dana Keppeler, Immenstaad (DE); Roland Hoefs, Besigheim (DE)

Correspondence Address: Striker Striker & Stenby, 103 East Neck Road, Huntington, NY, 11743, US

(21) Appl. No.: 10/485,653

(22) PCT Filed: Nov. 8, 2002
(86) PCT No.: PCT/DE02/04170

(30) Foreign Application Priority Data
Nov. 8, 2001 (DE) 101 54 870.2

(51) Int. Cl. H02K 9/00

(52) U.S. Cl. 310/68 D; 310/58

(57) ABSTRACT

The invention relates to an electrical machine, preferably a rotary-current generator (10) for motor vehicles, having a rectifier unit (11) on a bearing plate (23) of the machine, in which bearing plate a rotating fan (28) is disposed; the rectifier unit is secured in heat-conducting fashion to a heat-conducting annular portion (23a) of the bearing plate (23), and the annular portion surrounds a region (23b) of the bearing plate (23) that is provided with openings (27) through which the cooling air aspirated by the fan (28) flows. The negative and positive diodes of each diode bridge of the rectifier unit are disposed, with an input-side connection part inserted between them, between a common positive and negative connection plate (15, 17) and with them forms the rectifier unit.

### PRIOR ART

The invention relates to an electrical machine, preferably a rotary-current generator for motor vehicles, having a rectifier unit, as generically defined by the preamble to claim 1.

In known rotary-current generators for motor vehicles, a rectifier unit is usually mounted on the rear face end of the rotary-current generator, the rotary-current generator being driven by the vehicle engine; the rectifier unit rectifies the three-phase alternating voltage, generated in the stator winding of the rotary-current generator, for charging an accumulator battery for the on-board electrical system of the motor vehicle. The rectifier bridge circuit of the structural unit comprises a plurality of diode bridges, each with a series-connected negative diode and positive diode. The negative diodes are secured and contacted on the anode side on a common negative heat sink, and the positive diodes are secured and contacted on the cathode side on a common positive heat sink, which at the same time form a negative connection plate and a positive connection plate, respectively. Their free ends are joined together via a switch connection to the individual diode bridges and are each connected on the input side to a phase terminal of the stator winding.

From U.S. Pat. No. 4,606,000, one such embodiment is known, in which the negative and positive connection plates are secured on the face end, insulated in sandwichlike fashion and resting on one another, on the rear bearing plate of the rotary-current generator. In the region of their diodes, the connection plates are offset from one another such that the diode terminals are accessible from outside, for making the switch connections. For dissipating the lost heat in the rectifier unit, the two connection plates are enlarged in such a way that they form heat sinks. Because of their large-area contact with it, the negative heat sink gives up the lost heat of the negative diodes to the rear bearing plate of the machine, while conversely the lost heat of the positive diodes is given up, both via the positive heat sink in a region of the heat sink provided with ventilating slits, to the cooling air of the rotary-current generator flowing through there and, because of the thermal conductivity in the stack, to the rear bearing plate via the negative heat sink.

The known embodiments have the disadvantage that because the connection plates are embodied as heat sinks, the rectifier unit has relatively large dimensions, so that only slight degrees of freedom remain for mounting the rectifier unit to the rear bearing plate of the machine. It is also complicated to embody the connection plates as heat sinks with cooling air conduits, and because of the relatively large masses of the heat sinks, there is a risk, if vibration or impacts occur, of slight relative motions between the rectifier parts and also between them and the bearing plate, which can cause interruptions in the rectifier bridge circuit.

With the present embodiment, the object is to give up the lost heat of the rectifier unit to the cooling air of the machine in the most efficient possible way, so as to keep the dimensions of the rectifier unit as small as possible.

### ADVANTAGES OF THE INVENTION

The electrical machine of the invention having the definitive characteristics of claim 1 has the advantage over the prior art that the lost heat of the rectifier unit is first distributed from the negative connection plate annularly in the bearing plate of the machine via a good heat conduction, and from there it reaches the radially farther inward openings, so that it can be absorbed uniformly there by the entire cooling air stream aspirated by the fan of the machine and passing through these openings. This combination of heat conduction and forced convection, by utilization of the relatively cool aspirated air in the region of the bearing plate near the axis leads to efficient cooling of the rectifier unit, which can thus be embodied advantageously as a compact, replaceable module of small dimensions.

A further advantage is obtained, which is that for mounting the rectifier unit to the face end of the bearing plate of the machine, considerably greater degrees of freedom exist, since the connection plates no longer need to be enlarged into heat sinks. As a result, the rectifier unit can also be produced and installed more economically. Moreover, because of its reduced masses, it can be secured to the bearing plate so as to be resistant to vibration.

By the provisions recited in the dependent claims, advantageous refinements of and improvements to the characteristics recited in the main claim are attained. For the best possible heat conduction in the bearing plate and good dissipation to the cooling air, it is proposed that the wall in the annular portion and in the region having the openings be embodied as thicker than the wall of the remaining regions of the bearing plate.

Good heat conduction is obtained particularly by providing that the annular portion of the bearing plate is embodied as a wide aluminum ring that is preferably integrated with the bearing plate. Expediently, the rear bearing plate is made from injection-molded aluminum. For limiting the axial dimensions of the machine, it is proposed that the rectifier unit advantageously be disposed in a recess of the annular portion, on the outside of the bearing plate.

Since in motor vehicles the electrical machines and in particular the rotary-current generators are designed for variously high limit temperatures, depending on the electrical load and on their mounting in the engine compartment of the motor vehicle, it is proposed, for machines with relatively high limit temperatures of the bearing plate, in a so-called hot application, that the rectifier unit be secured to the bearing plate via a heat-distributing supplementary body seated semicircularly on the annular portion of the bearing plate. To improve the heat transfer, the rectifier unit and/or the supplementary body is connected to the bearing plate and to the supplementary body via a heat-conducting paste and/or heat-conducting foil.

Since in wider openings the cooling air flow becomes more turbulent, the heat transmission coefficient is thus increased compared to the provision of cooling fins. To achieve both good heat conduction in the walls between the individual openings and good heat dissipation to the cooling air stream in the openings, it is proposed that the openings in the bearing plate be disposed in gridlike form and embodied as honeycomblike shafts. The length of the shafts is predetermined by the thickness of the bearing plate in this region, and the requisite surface area for the heat dissipation by convection should be optimized by way of the width and number of shafts.

To be able to embody the rectifier unit as a compact module, it is provided that the negative and positive diodes of each diode bridge of the rectifier unit comprise semiconductor substrates, which with their connection part on the input side inserted between them each form a stack located between the positive and negative connection plates of the rectifier unit; the stacks are disposed side by side and embedded in the insulating material.

Since in most cases, the individual phases of the stator winding of the electrical machine are already interconnected in a Y connection in the region of their rear end windings, their connection wires that are brought to the outside can advantageously be connected directly, each to the respective connection part of a diode bridge of the rectifier unit. In electrical machines whose stator winding has connection wires brought to the outside, conversely, it is expedient to dispose a connection plate on the bearing plate, by way of which plate the connection wires of the stator winding can be interconnected with one another and/or with the input-side connection parts of the diode bridges of the rectifier unit.

### DRAWING

The invention is described in further detail below by exemplary embodiments in conjunction with the drawings.

FIG. 1 shows the circuit principle of a rotary-current generator for motor vehicles, with a rectifier unit;

FIG. 2 shows the rectifier unit as a compact module, in an enlarged view;

FIG. 3 shows the longitudinal section through the rear end of a rotary-current generator with the novel bearing plate, as the first exemplary embodiment;

FIG. 4 shows a second exemplary embodiment of the rear bearing plate with the rectifier unit, in a top view; and

FIG. 5 shows the exemplary embodiment in longitudinal section.

FIG. 6 shows a third exemplary embodiment of a bearing plate with the rectifier unit in a top view; and

FIG. 7 shows the longitudinal section for it.

### DESCRIPTION OF THE EXEMPLARY EMBODIMENTS

In FIG. 1, a rotary-current generator 10, driven by a motor vehicle motor, and a rectifier unit 11 connected to the rotary-current generator on the input side are shown in terms of their circuitry. The rotary-current generator 10 has a stator winding, embodied as a Y connection, with the phase conductors R, S and T; each phase conductor comprises two coils connected parallel to one another. In the rectifier unit 11, three diode bridges 13, comprising two series-connected diodes, are connected parallel to form a rectifier bridge circuit. The diode bridges 13 are connected with their negative diodes 14 on the anode side to a common negative pole 15, and the positive diodes 16 are connected on the cathode side to a common positive pole 17; the negative and positive poles form the direct-current output of the rotary-current generator 10 for supplying an accumulator battery in the on-board electrical system of the motor vehicle. Between the negative diode 14 and the positive diode 16 of each diode bridge 13, a connection part 18 is inserted. The end of a respective phase conductor R, S, T of the stator winding 12 is connected to these connection parts 18 that form the input to the rectifier unit 11.

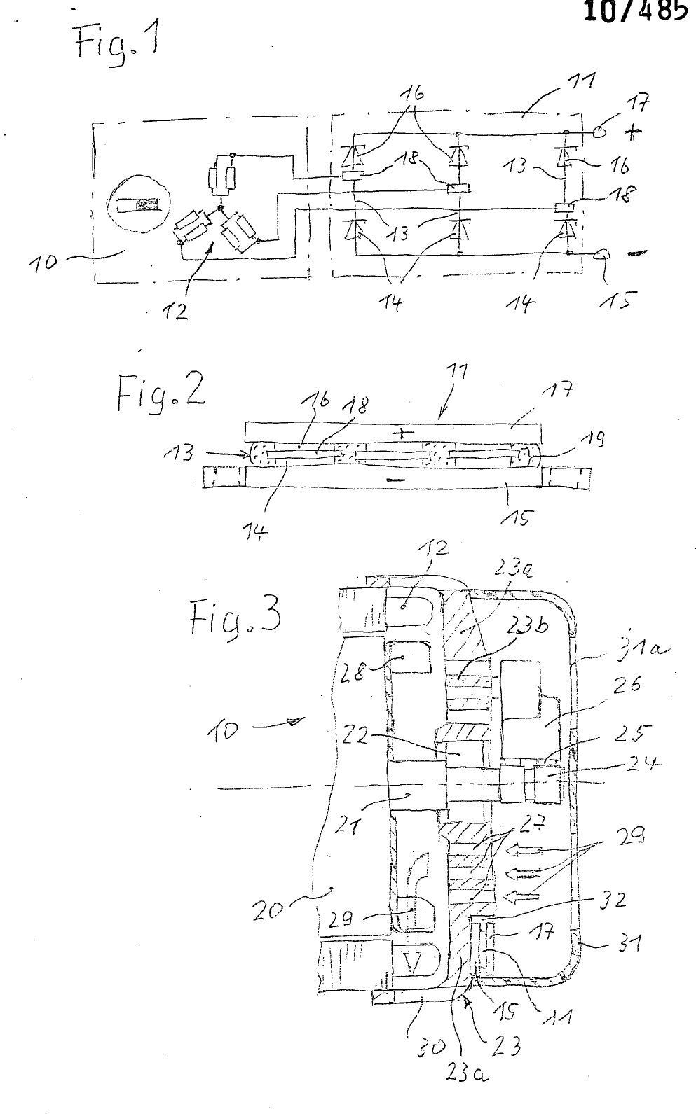

It can be seen from FIG. 2 that the rectifier unit 11 forms a compact, interchangeable rectifier module, in which the positive pole 17 is embodied as a positive connection plate, and the negative pole 15 is embodied as a negative connection plate, of aluminum or some other material that is a good current and heat conductor. It can also be seen from this drawing that the negative diodes 14 and positive diodes 16 of each diode bridge 13 comprise semiconductor substrates, which with their connection part 18 disposed in between form three stacks 19 disposed side by side, which are each located between the negative connection plate 15 and positive connection plate 17 and are embodied in insulating material.

FIG. 3 shows the rear end of the rotary-current generator 10 in longitudinal section; its claw pole rotor 20 is received in a known manner with its rotor shaft 21 in a bearing 22 on the rear bearing plate 23, and the end, protruding out of the bearing plate 23, of the rotor shaft 21 has a wiper ring arrangement 24. The exciter winding, not shown, of the claw pole rotor 20 is supplied with exciter current via the wiper ring arrangement 24 of carbon brushes 25 of a brush holder 26 secured to the face end of the bearing plate 23.

The rectifier unit 11 is secured in heat-conducting fashion by its negative connection plate 15 to a heat-conducting annular portion 23a of the bearing plate 23. The annular portion 23a of the bearing plate 23 farther away from the axis surrounds a region 23b of the bearing plate 23 that is closer to the axis and that is provided with axially extending openings 27 arranged in gridlike form.

A fan 28 is secured to the rear face end of the claw pole rotor 20 and in operation of the rotary-current generator generates a cooling air stream 29 represented by arrows. The cooling air is aspirated by the fan 28 in the region near the axis and radially outward is blown to the outside, past the rear end windings of the stator winding 12, through ventilation slits 30. The cooling air is first aspirated through openings 31a in the face end of a protective cap 31 that covers the wiper ring arrangement 24, brush holder 26 and rectifier unit 11; from there, the cooling air then flows relatively uniformly inward, in the region near the axis, through the openings 27 in the bearing plate 23. Both in the annular portion 23a of the bearing plate and in the inner region 23b enclosed by the bearing plate and having the openings 27, the wall is embodied as thicker than in the other regions, for instance at the outer circumference of the bearing plate 23 that encloses the rear end windings of the stator winding 12. At least the annular portion 23a of the bearing plate 23 that carries the rectifier unit 11 is embodied as a wide aluminum ring, in order to achieve good, uniform distribution of the lost heat of the rectifier unit 11. Since in most cases the bearing plate 23 is an injection-molded aluminum part, in this case as well the aluminum ring, as an annular portion 23a, is an integral component of the bearing plate 23. However, as an alternative, given different materials, it is equally possible for the annular portion 23a to be spray-coated with the material comprising the bearing plate 23. It can be seen from FIG. 3 that the annular portion 23a of the bearing plate 23 tapers conically toward the outside, and the rectifier unit 11 is disposed in a recess 32 in the annular portion 23a, on the outside of the bearing plate 23.

In operation of the rotary-current generator 10, as a result of the rectification of the alternating voltage in the three phase conductors R, S and T by the diodes 14 and 16 in the rectifier unit 11, a lost heat is generated which is initially absorbed by the negative connection plate 15 and is introduced into the bearing plate by way of the large-area contact of this plate 15 with the annular portion 23a of the bearing plate 23. There, because of the good conduction, the lost heat is distributed uniformly over the annular portion 23a, and from there it flows radially inward into the region 23b having the openings 27. At the walls of the openings 27, the lost heat of the rectifier unit 11 is now given up by convection to the cooling air that is aspirated by the fan 28 and is flowing through these openings. The openings can be embodied as a bores or as shafts of various cross sections; the width of the openings 27 is selected such that the cooling air flowing through them generates a turbulent flow there, for the sake of better heat dissipation. The large surface area at the openings 27 or shafts required for the convection is created by means of the thickness of material of the bearing plate 23 in this inner region 23b.

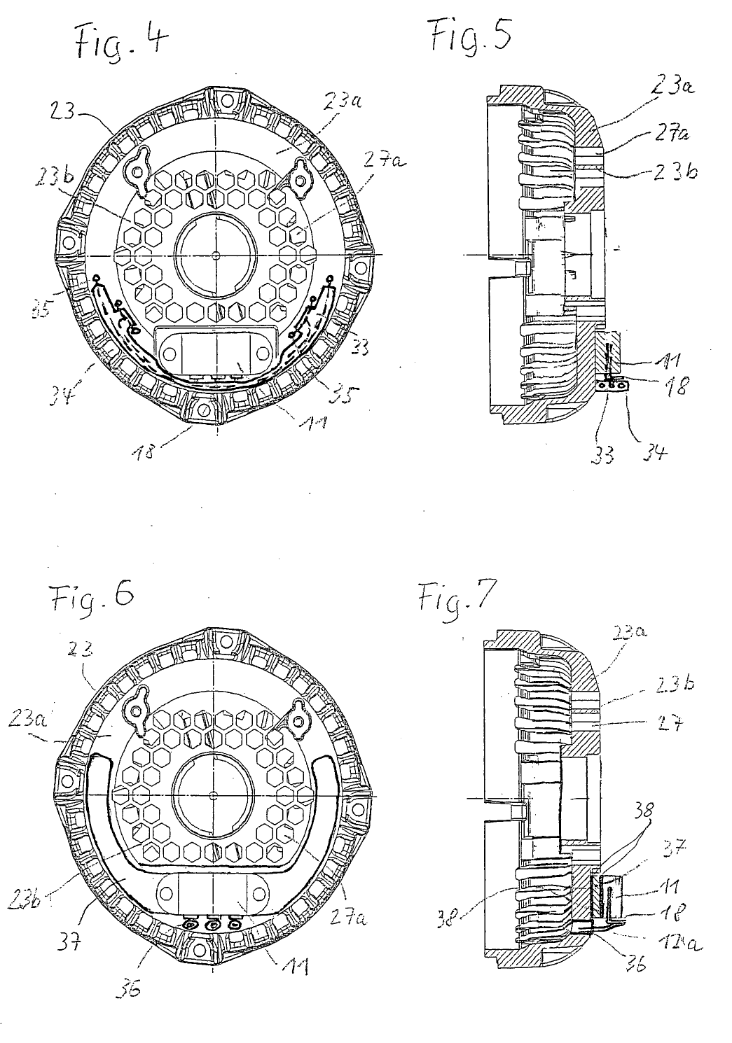

In FIGS. 4 and 5, a further embodiment of the bearing plate 23 is shown; the openings in the inner region 23b, surrounded by the annular portion 23a with the rectifier unit 11, are annularly disposed shafts 27a embodied in honeycomblike fashion. It can also be seen in these drawings that to produce the connections between the stator winding 12 of the rotary-current generator and the input-side connection parts 18 of the rectifier unit 11, a terminal connector 33 is disposed on the annular portion 23a of the bearing plate 23. While the six free winding ends of the three phase conductor R, S, T are brought to the outside from the rear end windings of the stator winding 12 through bores of the bearing plate 23, the three input-side connection parts 18 are located on the lower long side of the rectifier unit 11. By way of three connecting leads 34, indicated by dashed lines, that are embedded in the terminal connector 33, the three connection parts 18 are interconnected, each at respective connection points 35, respectively with two connection wires of a phase conductor of the stator winding 12.

FIGS. 6 and 7 show, as a further embodiment, the bearing plate 23 with the rectifier unit 11; the stator winding 12, with its connection wires 12a brought to the outside at the rear end windings, is passed through side-by-side bores 36 of the bearing plate 23 in the region of the rectifier unit 11, where they are each connected directly to the connection part 18 of a diode bridge 13 of the rectifier unit 11. In this exemplary embodiment, for the rectifier unit 11, a so-called hot application to the bearing plate 23 is provided, in the event that the bearing plate of the rotary-current generator 11 is already taking on a relatively high operating temperature because of a high load factor and/or an unfavorable installed position in the engine compartment of the motor vehicle. In this version, the heat gradient between the rectifier unit 11 and the bearing plate 23 is less than in the normal situation, and as a result the heat dissipation and heat distribution at the annular portion 23a of the bearing plate 23 is also made more difficult. To assure adequate dissipation of the lost heat from the rectifier unit 11 in this case as well, it is provided that the rectifier unit 11 be secured to a heat-distributing supplementary body 37 embodied semicircularly, which rests with its back side flat on the annular portion 23a of the bearing plate 23. For an optimal heat transfer from the rectifier unit 11 to the supplementary body 37 and from the supplementary body 37 to the bearing plate 23, a heat-conducting paste and optionally also a heat-conducting foil 38 is inserted between these parts.

Because the cooling air is aspirated by the fan 28 of the rotary-current generator 10 near the axis, it is assured in all three exemplary embodiments that the heated cooling air emerging radially will not flow back into the aspiration region by way of circulation. This is also reinforced by the protective cap 31 on the face end of the bearing plate. Where there is direct electrical contact of the rectifier unit 11 with the winding ends 12a of the stator winding 12, the terminal connector 33 of FIG. 4 is omitted, reducing the number of individual components. Another feature common to all three exemplary embodiments is the use of the rear bearing plate 23 as a ground terminal, which is electrically connected to the negative connection plate 15 of the rectifier unit 11. A positive connection terminal can be mounted for instance directly on the positive connection plate 17 of the rectifier unit 11, or is for example secured in insulated fashion on the bearing plate 23 and connected electrically to the positive connection plate via a busbar.

1. An electrical machine, preferably a rotary-current generator for motor vehicles, having a rectifier unit (11), secured to a bearing plate (23) of the machine, which unit is cooled by a fan (28) rotating in the bearing plate (23), and whose rectifier bridge circuit is connected on the input side to a stator winding (12) carrying a multiphase alternating voltage and on the output side to a direct-current output of the electrical machine, and a plurality of diode bridges (13) each comprising two series-connected diodes are seated with the anode of their negative diode (14) on a common negative connection plate (15) and with the cathode of their positive diode (16) on a common positive connection plate (17), and the negative connection plate (15) is secured to a heat-conducting annular portion (23a) of the bearing plate (23) in heat-conducting fashion, and the annular portion (23a) surrounds a region (23b) of the bearing plate (23) that is provided with openings (27), through which the cooling air aspirated by the fan (28) of the machine flows, characterized in that the negative and positive diodes (14, 16) of each diode bridge (13) are stacked one above the other and are each disposed, with a respective connection part (18) on the input side inserted between them, between the respective common positive and negative connection plates (17, 15) and with them form the rectifier unit (11).

2. The electrical machine of claim 1, characterized in that the wall in the annular portion (23a) and in the region (23b) having the openings (27) is thicker than the wall of the remaining regions of the bearing plate (23).

3. The electrical machine of claim 2, characterized in that the annular portion (23a) is embodied as a wide aluminum ring.

4. The electrical machine of claim 3, characterized in that the aluminum ring is integrated with the bearing plate (23).

5. The electrical machine of claim 2, characterized in that the rectifier unit (11) is disposed in a recess (32) in the annular portion (23a) on the outside of the bearing plate (32).

6. The electrical machine of claim 1, characterized in that the openings (27) in the face-end region (23b) of the bearing plate (23) are disposed in the form of a grid and are preferably embodied as honeycomblike shafts.

7. The electrical machine of claim 1, characterized in that the rectifier unit (11) is secured to the bearing plate (23) via a heat-distributing supplementary body (37) resting semicircularly on the annular portion (23a) of the bearing plate (23).

8. The electrical machine of claim 7, characterized in that the rectifier unit (11) and/or the supplementary body (37) is joined to the bearing plate (23) and the supplementary body (37), respectively, via a heat-conducting paste and/or heat-conducting foil (38).

9. The electrical machine of claim 1, characterized in that the negative and positive diodes (14, 16) of each diode bridge (13) of the rectifier unit (11) comprise semiconductor substrates, which with their connection part (18) on the input side inserted between them each form a stack (19) located between the positive and negative connection plates (17, 15) of the rectifier unit (11).

10. The electrical machine of claim 9, characterized in that the rectifier unit (11) is embodied as a compact, interchangeable module with stacks (19) disposed side by side and embedded in insulating material.
